(19) United States
(12) Patent Application Publication
(10) Pub. No.: US 2025/0250509 A1
(43) Pub. Date: Aug. 7, 2025

(54) LIQUID DETERGENT COMPOSITION

(71) Applicant: KAO CORPORATION, Tokyo (JP)

(72) Inventors: Kan JI, Wakayama -shi, Wakayama (JP); Seiji YANO, Wakayama -shi, Wakayama (JP)

(73) Assignee: KAO CORPORATION, Tokyo (JP)

(21) Appl. No.: 18/856,116

(22) PCT Filed: Apr. 11, 2023
(86) PCT No.: PCT/JP2023/014696

§ 371 Date: Oct. 11, 2024

(30) Foreign Application Priority Data
Apr. 13, 2022 (JP) 2022-066044

(51) Int. Cl. C11D 1/86; C11D 1/14; C11D 1/62; C11D 1/72; C11D 3/20

(52) U.S. Cl. CPC C11D 1/86; C11D 3/2079; C11D 1/143; C11D 1/62; C11D 1/72

(57) ABSTRACT

Provided are a liquid detergent composition that exhibits good liquid-phase stability, and provides excellent washing performance to sebum stains, softening performance, and anti-wrinkle performance for textile products even when water having high hardness is used, and a method for washing textile products that provides excellent washing performance to sebum stains, softening performance, and anti-wrinkle performance for textile products even when water having high hardness is used.

A liquid detergent composition containing: (a) an internal olefin sulfonate with 16 or more and 24 or less carbons; (b) a cationic surfactant; (c) a nonionic surfactant; and water.

### FIELD OF THE INVENTION

The present invention relates to a liquid detergent composition and a method for washing textile products.

### BACKGROUND OF THE INVENTION

In recent years, performances of liquid detergent compositions for textile products demanded by consumers have been diversified, and not only performance in washing but also avoidance of deteriorated performance in finishing (softening performance and anti-wrinkle performance for textile products) have been required.

Anionic surfactants, in particular, alkylbenzene sulfonates and olefin sulfonates, moreover, internal olefin sulfonates obtained from internal olefins having a double bond not at an end of the olefin chain but in the inside as a raw material, and nonionic surfactants Containing an oxyalkylene group with two to three carbons are conventionally used widely as washing components for home use and industrial use.

JP-A 2017-214678 discloses a method for washing textile products, the method including the following step 1 and step 2:
step 1: a step of washing textile products by bringing a washing liquid obtained by mixing water and (A) an internal olefin sulfonate with 14 or more and 16 or less carbons [hereinafter referred to as component (A)] into contact with the textile products; and
step 2: a step of treating the textile products by bringing a treatment liquid obtained by mixing water and a finishing agent composition for textile products into contact with the textile products washed in step 1.

WO-A 2019/049896 discloses a treatment agent composition for textile products, the treatment agent composition containing the following component (A) and component (B):
component (A): an internal olefin sulfonate with 16 or more and 24 or less carbons; and
component (B): a softening base for textile products.

CN-A 108102810 discloses a liquid detergent composition for clothing, the liquid detergent composition containing components (a) to (d) shown below and water, wherein a content of component (d) is 0.1 mass % or more and 2.2 mass % or less, a mass ratio, (c)/[(a)+(b)], is 0.5 or more and 5 or less, the composition contains or does not contain a fatty acid as component (e), and a mass ratio, (e)/(a), is less than 1: component (a): an anionic surfactant selected from polyoxyalkylene group alkyl ether sulfates and compounds having an alkyl group with 8 or more and 20 or less carbons and a sulfonic acid group;
component (b): a specific cationic surfactant represented by the general formula (1);
component (c): a specific nonionic surfactant represented by the general formula (4); and
component (d): one or two or more dissolution aids of components (d1), (d2) and (d3).

### SUMMARY OF THE INVENTION

While detergent compositions with an internal olefin sulfonate having a hydrocarbon group with a specific number of carbons as a surfactant are known to be excellent not only in performance in washing for textile products but also in performance in finishing (softening performance and anti-wrinkle performance for textile products), the present inventors have found that if such detergent compositions with an internal olefin sulfonate are used for washing textile products with water having high hardness, performance in washing and that in finishing are not achieved in combination in a manner satisfactory to consumers.

The present invention provides a liquid detergent composition that exhibits good liquid-phase stability, and provides excellent washing performance to sebum stains, softening performance and anti-wrinkle performance for textile products even when water having high hardness is used, and a method for washing textile products that provides excellent washing performance to sebum stains, softening performance and anti-wrinkle performance for textile products even when water having high hardness is used.

The present invention relates to a liquid detergent composition containing: (a) an internal olefin sulfonate with 16 or more and 24 or less carbons (hereinafter referred to as component (a)); (b) a cationic surfactant (hereinafter referred to as component (b)); (c) a nonionic surfactant (hereinafter referred to as component (c)); and water.

Further, the present invention relates to a method for washing textile products, including washing textile products with a washing liquid containing: (a) an internal olefin sulfonate with 16 or more and 24 or less carbons (hereinafter referred to as component (a)); (b) a cationic surfactant (hereinafter referred to as component (b)); (c) a nonionic surfactant (hereinafter referred to as component (c)); and water.

The present invention provides a liquid detergent composition that exhibits good liquid-phase stability and provides excellent washing performance to sebum stains, softening performance and anti-wrinkle performance for textile products, and a method for washing textile products that provides excellent washing performance to sebum stains, softening performance and anti-wrinkle performance for textile products.

### EMBODIMENTS OF THE INVENTION

### Liquid Detergent Composition

While the reason why the liquid detergent composition of the present invention exhibits good liquid-phase stability and provides excellent washing performance to sebum stains, softening performance and anti-wrinkle performance for textile products is not Completely elucidated, the following is inferred.

Component (a) forms micelles and vesicles in a washing liquid, and the micelles act on sebum stains adhering to a textile product and the vesicles modify the surface of the textile product; as a result, washing performance to sebum stains and finishing performance (softening performance, anti-wrinkle performance) are successfully achieved in combination.

However, if water having high hardness is used for the washing liquid, component (a) bonds to a large amount of calcium contained in the water to form a large number of vesicles, which leads to reduced formation of micelles and results in insufficient washing performance to sebum stains. In view of this, use of a combination of component (a) and component (c) having high washing performance to sebum stains is contemplated; in this case, however, component (a) is solubilized by component (c) and does not bond to calcium contained in the water, failing to form vesicles to result in insufficient finishing performance (softening performance, anti-wrinkle performance).

In such circumstances, the present inventors have found the liquid detergent composition of the present invention, for which component (a), component (b) and component (c) are used in combination.

The reason why the liquid detergent composition of the present invention achieves washing performance to sebum stains and finishing performance (softening performance, anti-wrinkle performance) in combination is inferred to be that when water having high hardness is used for a washing liquid, component (a) and component (b) form a complex, which serves as a nuclei to facilitate bonding between component (a) and calcium contained in the water and allow the formation of vesicles, and further, component (c) acts on washing performance to sebum stains.

In addition, the reason for the successful achievement of good liquid-phase stability is inferred to be that when the liquid detergent composition of the present invention is in the form of a stock solution before being diluted with water for use as a washing liquid, component (a) and component (b) form mixed micelles with component (c) and are solubilized in the stock solution.

### Component (a)

Component (a) of the present invention is an internal olefin sulfonate with 16 or more and 24 or less carbons.

The carbon number of the internal olefin sulfonate with 16 or more and 24 or less carbons represents the carbon number of an internal olefin to which a sulfonate is covalently bonded. The internal olefin sulfonate with 16 or more and 24 or less carbons has 17 or more and preferably 18 or more carbons from the viewpoints of anti-wrinkle performance and softening performance for textile products, and 24 or less, preferably 22 or less and more preferably 20 or less carbons from the viewpoint of washing performance to sebum stains.

The internal olefin sulfonate of the present invention is a sulfonate obtained by sulfonating, neutralizing and hydrolyzing an internal olefin (an olefin having a double bond inside the olefin chain) with 16 or more and 24 or less carbons as a raw material. The internal olefin also contains a minute amount of a so-called alfa-olefin (hereinafter also referred to as an α-olefin), which has a double bond at position 1 of the carbon chain. Further, a β-sultone is quantitatively produced through the sulfonation of the internal olefin, part of the β-sultone is changed into a γ-sultone and an olefin sulfonic acid, and these are further converted into a hydroxy alkane sulfonate and an olefin sulfonate in the neutralizing and hydrolyzing processes (for example, J. Am. Oil Chem. Soc. 69, 39 (1992)). Here, a hydroxy alkane sulfonate and an olefin sulfonate to be obtained respectively have a hydroxy group inside the alkane chain and a double bond inside the olefin chain. Further, a product to be obtained is mainly a mixture of these, and may sometimes also partially contain a minute amount of a hydroxy alkane sulfonate having a hydroxy group at the end of the carbon chain or an olefin sulfonate having a double bond at the end of the carbon chain.

In the present specification, each of these products and a mixture of them are collectively referred to as the internal olefin sulfonate (component (a)). Further, the hydroxy alkane sulfonates are referred to as hydroxy species of the internal olefin sulfonate (hereinafter also referred to as HAS), and the olefin sulfonates are referred to as olefin species of the internal olefin sulfonate (hereinafter also referred to as IOS).

Note that a mass ratio between the compounds of HAS and IOS in component (a) can be measured by a high-performance liquid chromatography mass spectrometer (hereinafter abbreviated as HPLC-MS). Specifically, the mass ratio can be determined from the HPLC-MS peak areas of component (a).

Examples of a salt of the internal olefin sulfonate include an alkali metal salt, an alkaline earth metal (½ atom) salt, and an ammonium salt or an organic ammonium salt. Examples of the alkali metal salt include a sodium salt and a potassium salt. Examples of the organic ammonium salt include an alkanol ammonium salt with 2 or more and 6 or less carbons. The salt of the internal olefin sulfonate is preferably an alkali metal salt, and more preferably one or more selected from a sodium salt and a potassium salt from the viewpoint of versatility.

As is clear from the above producing method, the internal olefin sulfonate of component (a) has a sulfonic acid group inside the carbon chain of the internal olefin sulfonate, which is, namely, an olefin chain or an alkane chain, and may sometimes also partially contain a minute amount of a compound having a sulfonic acid group at the end of the carbon chain.

A content of an internal olefin sulfonate with a sulfonic acid group present at position 5 or more and preferably position 5 or more and 9 or less in component (a) is preferably 5 mass % or more, more preferably 10 mass % or more, further preferably 15 mass % or more, furthermore preferably 20 mass % or more, furthermore preferably 30 mass % or more and furthermore preferably 35 mass % or more, and preferably 60 mass % or less, more preferably 50 mass % or less and further preferably 40 mass % or less from the viewpoints of anti-wrinkle performance and softening performance for textile products.

A mass ratio of a content of an internal olefin sulfonate with a sulfonic acid group present at position 2 or more and 4 or less [hereinafter sometimes referred to as (IO-1S)] to a content of an internal olefin sulfonate with a sulfonic acid group present at position 5 or more and preferably position 5 or more and 9 or less [hereinafter sometimes referred to as (IO-2S)] in component (a), (IO-1S)/(IO-2S), is preferably 0.5 or more, more preferably 0.7 or more, further preferably 1.0 or more and furthermore preferably 1.4 or more, and preferably 10 or less, more preferably 6 or less, further preferably 5 or less, furthermore preferably 3 or less, furthermore preferably 2 or less and furthermore preferably 1.8 or less from the viewpoints of anti-wrinkle performance and softening performance for textile products.

Note that the contents of the compounds having a sulfonic acid group at different positions in component (a) can be measured by HPLC-MS. The contents of the compounds having a sulfonic acid group at different positions in the present specification are determined as mass ratios based on the HPLC-MS peak areas of the compounds having a sulfonic acid group at their respective positions in the total of HAS species of component (a1).

In component (a), a content of an olefin sulfonate with a sulfonic acid group present at position 1 is preferably 10 mass % or less, more preferably 7 mass % or less, further preferably 5 mass % or less, furthermore preferably 3 mass % or less and furthermore preferably 2 mass % or less from the viewpoint of capability of imparting good anti-wrinkle performance to textile products even when the temperature of water used for washing is as low as 0° C. or more and 15° C. or less, and preferably 0.01 mass % or more from the viewpoints of reduction of production costs and improvement of productivity.

The positions of a sulfonic acid group in these compounds are positions in the olefin chains or the alkane chains.

The internal olefin sulfonate can be a mixture of hydroxy species and olefin species. A mass ratio of a Content of olefin species of the internal olefin sulfonate to a content of hydroxy species of the internal olefin sulfonate in component (a) (olefin species/hydroxy species) can be 0/100 or more, further 5/95 or more and further 10/90 or more, and 50/50 or less, further 40/60 or less, further 30/70 or less, further 25/75 or less and further 20/80 or less.

The mass ratio of a content of olefin species of the internal olefin sulfonate to a content of hydroxy species of the internal olefin sulfonate in component (a) can be measured by HPLC-MS with a method described in Examples.

Component (a) can be produced by sulfonating, neutralizing and hydrolyzing an internal olefin with 16 or more and 24 or less carbons as a raw material. The sulfonation reaction can be carried out by reacting 1.0 to 1.2 mol of sulfur trioxide gas with 1 mol of the internal olefin. It can be carried out at a reaction temperature of 20 to 40° C.

The neutralization is carried out by reacting an aqueous alkali solution such as sodium hydroxide, ammonia, 2-aminoethanol or the like in an amount 1.0 to 1.5 molar times the theoretic value for a sulfonic acid group. The hydrolysis reaction may be carried out at 90 to 200° C. for 30 minutes to 3 hours in the presence of water. These reactions can be carried out in succession. Further, after the reactions are completed, purification can be carried out by extraction, washing or the like.

Note that in producing the internal olefin sulfonate (a), sulfonation, neutralization, and hydrolysis treatments may be carried out using raw material internal olefins with a distribution of carbon numbers of 16 or more and 24 or less, and sulfonation, neutralization, and hydrolysis treatments may be carried out using raw material internal olefins with a single carbon number, or a plurality of internal olefin sulfonates with different carbon numbers that have been produced in advance may be mixed together, as necessary.

In the present invention, the internal olefin refers to an olefin having a double bond inside the olefin chain, as described above. The internal olefin as a raw material of component (a) has 16 or more and 24 or less carbons. A single internal olefin or a combination of two or more internal olefins may be used as a raw material of component (a).

### Component (b)

Component (b) of the present invention is a cationic surfactant.

The cationic surfactant as component (b) is preferably one or more selected from compounds represented by the general formula (b1) shown below and compounds represented by the general formula (b2) shown below from the viewpoints of easiness of interaction with component (a) and capability of imparting good anti-wrinkle properties and softness to textile products:

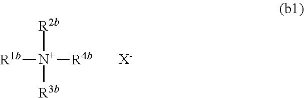

wherein R^{1b} is an aliphatic hydrocarbon group with 8 or more and 18 or less carbons, R^{2b} is a group selected from aliphatic hydrocarbon groups with 8 or more and 18 or less carbons, alkyl groups with 1 or more and 3 or less carbons and hydroxyalkyl groups with 1 or more and 3 or less carbons, R^{3b} and R^{4b} are each independently a group selected from alkyl groups with 1 or more and 3 or less carbons and hydroxyalkyl groups with 1 or more and 3 or less carbons, and X⁻ is an anion,

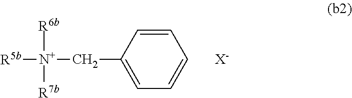

wherein R^{5b} is an aliphatic hydrocarbon group with 8 or more and 18 or less carbons, R^{6b} and R^{7b} are each independently a group selected from alkyl groups with 1 or more and 3 or less carbons and hydroxyalkyl groups with 1 or more and 3 or less carbons, and X⁻ is an anion.

R^{1b} in the general formula (b1) has 8 or more, preferably 12 or more and more preferably 14 or more carbons from the viewpoints of anti-wrinkle performance and softening performance for textile products, and 18 or less, preferably 16 or less and more preferably 16 carbons from the viewpoint of liquid-phase stability. R^{1b} is preferably an alkyl group or an alkenyl group and preferably an alkyl group.

R^{2b} in the general formula (b1) is a group selected from aliphatic hydrocarbon groups with 8 or more and 18 or less carbons, alkyl groups with 1 or more and 3 or less carbons and hydroxyalkyl groups with 1 or more and 3 or less carbons. Examples of the alkyl groups with 1 or more and 3 or less carbons include a methyl group, an ethyl group and a propyl group. Examples of the hydroxyalkyl groups with 1 or more and 3 or less carbons include a hydroxymethyl group, a hydroxyethyl group and a hydroxypropyl group.

If R^{2b} is an aliphatic hydrocarbon group with 8 or more and 18 or less carbons, R^{2b} is preferably an alkyl group or an alkenyl group and preferably an alkyl group with 8 or more and preferably 10 or more carbons from the viewpoints of anti-wrinkle performance and softening performance for textile products, and 18 or less, preferably 16 or less and more preferably 14 or less carbons from the viewpoint of liquid-phase stability.

Specific examples of R^{2b} include a group selected from a methyl group, an ethyl group and a hydroxypropyl group.

R^{3b} and R^{4b} in the general formula (b1) are each independently a group selected from alkyl groups with 1 or more and 3 or less carbons and hydroxyalkyl groups with 1 or more and 3 or less carbons. Preferably, R^{3b} and R^{4b} are each independently a group selected from alkyl groups with 1 or more and 3 or less carbons. Examples of the alkyl groups with 1 or more and 3 or less carbons include a methyl group, an ethyl group and a propyl group. Examples of the hydroxyalkyl groups with 1 or more and 3 or less carbons include a hydroxymethyl group, a hydroxyethyl group and a hydroxypropyl group.

X⁻ in the general formula (b1) is an anion. Examples of the anion include a halogen ion such as a chloride ion, a bromide ion and an iodide ion. Further, examples include an alkylsulfate ion with 1 or more and 3 or less carbons, for example, a methylsulfate ion, an ethylsulfate ion and a propylsulfate ion.

Examples of preferred compounds as the compound of the general formula (b1) include one or more selected from an N-alkyl-N,N,N-trimethylammonium salt whose alkyl group has 12 or more and 18 or less carbons, an N,N-dialkyl-N,N-dimethyl-ammonium salt whose alkyl group has 8 or more and 16 or less carbons and an N-alkyl-N,N-dimethyl-N-ethylammonium salt whose alkyl group has 12 or more and 16 or less carbons.

R^{5b} in the general formula (b2) is an aliphatic hydrocarbon group with 8 or more and 18 or less carbons. R^{5b} has 8 or more, preferably 10 or more and more preferably 12 or more carbons from the viewpoints of anti-wrinkle performance and softening performance for textile products, and 18 or less and preferably 16 or less from the viewpoint of liquid-phase stability. R^{5b} is preferably an alkyl group or an alkenyl group and preferably an alkyl group.

R^{6b} and R^{7b} in the general formula (b2) are each independently a group selected from alkyl groups with 1 or more and 3 or less carbons and hydroxyalkyl groups with 1 or more and 3 or less carbons. Preferably, R^{6b} and R^{7b} are each independently a group selected from alkyl groups with 1 or more and 3 or less carbons. Examples of the alkyl groups with 1 or more and 3 or less carbons include a methyl group, an ethyl group and a propyl group. Examples of the hydroxyalkyl groups with 1 or more and 3 or less carbons include a hydroxymethyl group, a hydroxyethyl group and a hydroxypropyl group.

X⁻ in the general formula (b2) is an anion. Examples of the anion include a halogen ion such as a chloride ion, a bromide ion and an iodide ion. Further, examples include an alkylsulfate ion with 1 or more and 3 or less carbons, for example, a methylsulfate ion, an ethylsulfate ion and a propylsulfate ion.

Specific examples of the compound of the general formula (b2) include one or more compounds selected from an N-octyl-N,N-dimethyl-N-benzylammonium salt, an N-decyl-N,N-dimethyl-N-benzylammonium salt, an N-dodecyl-N,N-dimethyl-N-benzylammonium salt, an N-tridecyl-N,N-dimethyl-N-benzylammonium salt, an N-tetradecyl-N, N-dimethyl-N-benzylammonium salt, an N-pentadecyl-N,N-dimethyl-N-benzylammonium salt, an N-hexadecyl-N,N-dimethyl-N-benzylammonium salt, an N-dodecyl-N,N-diethyl-N-benzylammonium salt, an N-tridecyl-N,N-diethyl-N-benzylammonium salt, an N-tetradecyl-N,N-diethyl-N-benzylammonium salt, an N-pentadecyl-N,N-diethyl-N-benzylammonium salt, an N-hexadecyl-N,N-diethyl-N-benzylammonium salt, an N-dodecyl-N-methyl-N-ethyl-N-benzylammonium salt, an N-tridecyl-N-methyl-N-ethyl-N-benzylammonium salt, an N-tetradecyl-N-methyl-N-ethyl-N-benzylammonium salt, an N-pentadecyl-N-methyl-N-ethyl-N-benzylammonium salt and an N-hexadecyl-N-methyl-N-ethyl-N-benzylammonium salt.

### Component (c)

Component (c) of the present invention is a nonionic surfactant.

From the viewpoint of washing performance to sebum stains, the nonionic surfactant as component (c) is preferably a compound represented by the following general formula (c1):

R^{1c}(CO)ₘO—(AO)ₙ—R^{2c} (c1)
wherein R^{1c} is an aliphatic hydrocarbon group with 8 or more and 18 or less carbons, R^{2c} is a hydrogen atom or a methyl group, CO is a carbonyl group, m is a number of 0 or 1, AO group is one or more groups selected from ethyleneoxy group and propyleneoxy group, and n is an average number of added moles, which is a number of 6 or more and 50 or less.

R^{1c} in the general formula (c1) has 8 or more, preferably 10 or more and more preferably 12 or more carbons, and 18 or less, preferably 16 or less and more preferably 14 or less carbons from the viewpoint of washing performance to sebum stains.

The aliphatic hydrocarbon group as R^{1c} is preferably a group selected from alkyl groups and alkenyl groups.

m in the general formula (c1) is preferably 0.

R^{2c} in the general formula (c1) is preferably a hydrogen atom.

AO group in the general formula (c1) is one or more groups selected from ethyleneoxy group and propyleneoxy group. When AO group includes ethyleneoxy group and propyleneoxy group, the ethyleneoxy group and the propyleneoxy group may be bonded in blocks or bonded at random. AO group is preferably a group including ethyleneoxy group from the viewpoint of capability of more reducing the residue of the surfactant on textile products.

n in the general formula (c1) is an average number of added moles, which is a number of 6 or more and 50 or less. n is 6 or more, preferably 8 or more, more preferably 10 or more and further preferably 12 or more from the viewpoint of capability of more reducing the residue of the surfactant on textile products, and 50 or less, preferably 40 or less, more preferably 30 or less and further preferably 25 or less from the viewpoint of washing performance to sebum stains.

When AO group in the general formula (c1) is ethyleneoxy group, n is 6 or more, preferably 8 or more, more preferably 10 or more and further preferably 12 or more from the viewpoint of capability of more reducing the residue of the surfactant on textile products, and 50 or less, preferably 40 or less, more preferably 30 or less and further preferably 25 or less from the viewpoint of washing performance to sebum stains.

When AO group in the general formula (c1) includes ethyleneoxy group and propyleneoxy group, an average number of added moles of the ethyleneoxy group is preferably 8 or more, more preferably 10 or more and further preferably 12 or more from the viewpoint of capability of more reducing the residue of the surfactant on textile products, and preferably 40 or less, more preferably 30 or less and further preferably 25 or less from the viewpoint of washing performance to sebum stains. An average number of added moles of propyleneoxy is preferably 0.3 or more, more preferably 0.6 or more and further preferably 1 or more, and preferably 7 or less, more preferably 5 or less, further preferably 4 or less and furthermore preferably 3 or less from the viewpoint of liquid-phase stability.

### Composition and Others

The liquid detergent composition of the present invention contains component (a) in an amount of preferably 4 mass % or more, more preferably 4.5 mass % or more and further preferably 5 mass % or more from the viewpoints of anti-wrinkle performance and softening performance for textile products, and preferably 40 mass % or less, more preferably 30 mass % or less, further preferably 20 mass % or less, furthermore preferably 15 mass % or less, furthermore preferably 10 mass % or less, furthermore preferably 9 mass % or less and furthermore preferably 8 mass % or less from the viewpoints of liquid-phase stability and washing performance to sebum stains.

Note that, for specification of the mass of component (a) in the liquid detergent composition of the present invention, values expressed in terms of a sodium salt are used.

The liquid detergent composition of the present invention contains component (b) in an amount of preferably 2.5 mass % or more, more preferably 3 mass % or more, further preferably 3.75 mass % or more and furthermore preferably 3.9 mass % or more from the viewpoints of anti-wrinkle performance and softening performance for textile products, and preferably 20 mass % or less, more preferably 15 mass % or less, further preferably 10 mass % or less, furthermore preferably 8 mass % or less, furthermore preferably 7 mass % or less, furthermore preferably 6 mass % or less and furthermore preferably 5 mass % or less from the viewpoint of washing performance to sebum stains.

Note that, for specification of the mass of component (b) in the liquid detergent composition of the present invention, values expressed in terms of a chloride salt are used.

The liquid detergent composition of the present invention contains component (c) in an amount of preferably 7.5 mass % or more, more preferably 10 mass % or more, further preferably 12 mass % or more, furthermore preferably 15 mass % or more and furthermore preferably 18 mass % or more from the viewpoint of washing performance to sebum stains, and preferably 35 mass % or less, more preferably 30 mass % or less, further preferably 25 mass % or less and furthermore preferably 22 mass % or less from the viewpoints of anti-wrinkle performance and softening performance for fibers.

A mass ratio of a content of component (a) to a content of component (b), (a)/(b), in the liquid detergent composition of the present invention is preferably 0.8 or more, more preferably 1 or more and further preferably 1.2 or more from the viewpoints of washing performance to sebum stains, liquid-phase stability and anti-wrinkle performance for fibers, and preferably 5 or less, more preferably 4 or less, further preferably 3 or less, furthermore preferably 2.5 or less, furthermore preferably 2 or less and furthermore preferably 1.8 or less from the viewpoints of washing performance to sebum stains, anti-wrinkle performance and softening performance for textile products.

A mass ratio of a content of component (c) to a total content of component (a) and component (b), (c)/[(a)+(b)], in the liquid detergent composition of the present invention is preferably 0.3 or more, more preferably 0.7 or more, further preferably 1 or more, furthermore preferably 1.5 or more and furthermore preferably 1.8 or more from the viewpoints of washing performance to sebum stains and liquid-phase stability, and preferably 2.5 or less, more preferably 2.3 or less and further preferably 2.2 or less from the viewpoints of anti-wrinkle performance and softening performance for textile products.

The liquid detergent composition of the present invention preferably further contains a fatty acid or a salt thereof as component (d) from the viewpoints of liquid-phase stability and finishing performance for textile products.

The fatty acid as component (d) preferably has 6 or more, more preferably 8 or more and further preferably 10 or more carbons, and preferably 16 or less, more preferably 14 or less and further preferably 12 carbons from the viewpoint of softening performance for textile products.

The fatty acid as component (d) is a linear fatty acid or a branched fatty acid and preferably a linear fatty acid,

The salt of the fatty acid as component (d) is preferably an alkali metal salt and more preferably a sodium salt or a potassium salt.

Examples of component (d) include one or more selected from hexanoic acid, heptanoic acid, caprylic acid, nonanoic acid, decanoic acid, undecylic acid, lauric acid, tridecylic acid, myristic acid, pentadecanoic acid, palmitic acid, palmitoleic acid, stearic acid, isostearic acid, oleic acid, elaidic acid, linoleic acid, linolenic acid and salts of them, and from the viewpoint of softening performance for textile products, it is preferably one or more selected from caprylic acid, decanoic acid, lauric acid, myristic acid and salts of them, and more preferably lauric acid or a salt thereof.

When the liquid detergent composition of the present invention contains component (d), it contains component (d) in an amount of preferably 0.5 mass % or more, more preferably 1 mass % or more and further preferably 1.5 mass % or more, and preferably 5 mass % or less, more preferably 4 mass % or less, further preferably 3 mass % or less and furthermore preferably 2.5 mass % or less from the viewpoints of liquid-phase stability and finishing performance for textile products.

Note that, for specification of the mass of component (d) in the liquid detergent composition of the present invention, values expressed in terms of an acid form are used.

When the liquid detergent composition of the present invention contains component (d), a mass ratio of a content of component (a) to a content of component (d), (a)/(d), is preferably 0.7 or more, more preferably 1.5 or more, further preferably 2.2 or more and furthermore preferably 2.5 or more, and preferably 8 or less, more preferably 6 or less, further preferably 4 or less and furthermore preferably 3.5 or less from the viewpoints of liquid-phase stability and softening performance for textile products.

The liquid detergent composition of the present invention can further contain an organic solvent having a hydroxyl group as component (e).

Component (e) is preferably an organic solvent whose CLogP is 0 or more and preferably 0.5 or more, and 3 or less and preferably 2 or less. In the present invention, calculated values determined with ChemProperty of ChemBioDraw Ultra ver. 14.0 from PerkinElmer, Inc. are used for CLogP. Higher values of CLogP indicate higher hydrophobicity.

Component (e) is preferably one or more organic solvents selected from the following component (e1) to component (e3):
component (e1): an alcohol with 3 or more and 8 or less carbons;
component (e2): an organic solvent having a hydrocarbon group with 2 or more and 8 or less carbons, an ether group and a hydroxyl group (with the proviso that aromatic groups are excluded from the hydrocarbon group); and
component (e3): an organic solvent having an aromatic group that may be partially substituted, an ether group and a hydroxyl group.

Specific examples of component (e1) to component (e3) are shown below. Each number in parentheses is a calculated value (CLogP) of each component determined with ChemProperty of ChemBioDraw Ultra ver. 14.0 from PerkinElmer, Inc.

Examples of the alcohol with 3 or more and 8 or less carbons as component (e1) include one or more selected from 1-propanol (0.29), 2-propanol (0.07) and phenol (1.48).

Examples of the organic solvent having a hydrocarbon group with 2 or more and 8 or less carbons, an ether group and a hydroxyl group as component (e2) include one or more selected from, for example, diethylene glycol diethyl ether (0.52), diethylene glycol monobutyl ether (0.67), dipropylene glycol monoethyl ether (0.23), 1-methoxy-2-propanol (−0.30), 1-ethoxy-2-propanol (0.09), 3-methoxy-3-methyl-1-butanol (0.18), 1,3-diethyl glycerin ether (0.11), triethyl glycerin ether (0.83), 1-pentyl glyceryl ether (0.54), 2-pentyl glyceryl ether (1.25), 1-octyl glyceryl ether (2.1) and 2-ethylhexyl glyceryl ether (2.0).

Examples of the organic solvent having an aromatic group that may be partially substituted, an ether group and a hydroxyl group as component (e3) include one or more selected from 2-phenoxyethanol (1.2), diethylene glycol monophenyl ether (1.25), triethylene glycol monophenyl ether (1.08), polyethylene glycol monophenyl ether having an average molecular weight of approximately 480 (uncalculatable), 2-benzyloxyethanol (1.1) and diethylene glycol monobenzyl ether (0.96).

When the liquid detergent composition of the present invention contains component (e), it contains component (e) in an amount of preferably 0.5 mass % or more, more preferably 1 mass % or more and further preferably 1.5 mass % or more from the viewpoint of liquid-phase stability, and preferably 15 mass % or less, more preferably 10 mass % or less, further preferably 7 mass % or less, furthermore preferably 5 mass % or less, furthermore preferably 3 mass % or less and furthermore preferably 2.5 mass % or less from the viewpoints of anti-wrinkle performance and softening performance for textile products.

The liquid detergent composition of the present invention can contain an alkanolamine as component (f).

Examples of the alkanolamine preferably include an amine compound, wherein the compound is a primary or higher and tertiary or lower monoamine compound and has 1 or more and 3 or less hydroxyalkyl groups with 2 or more and 4 or less carbons bonding to a nitrogen atom. If the alkanolamine has a group other than the hydroxyalkyl group, examples of such a group include an organic group, for example, an alkyl group with 1 or more and 4 or less carbons and preferably a methyl group.

Specific examples of the alkanolamine can include monoethanolamine, diethanolamine, triethanolamine, monopropanolamine, dipropanolamine, tripropanolamine, N-methylethanolamine, N-methylpropanolamine, N-ethylethanolamine and the like, and one or more of them can be used.

Component (f) may be combined as a counterion to the internal olefin sulfonate of component (a) in the composition. Depending on the pH of the composition, component (f) may be present as an ammonium ion in the composition. In the present invention, such a compound in the form of an ammonium ion is also regarded as component (f).

The liquid detergent composition of the present invention contains water. For the water, deionized water (sometimes referred to as ion-exchanged water) or water obtained by adding 1 mg/kg or more and 5 mg/kg or less of sodium hypochlorite to ion-exchanged water can be used. Alternatively, tap water can be used.

The liquid detergent composition of the present invention contains water in an amount of preferably 30 mass % or more, more preferably 40 mass % or more and further preferably 50 mass % or more, and preferably 90 mass % or less, more preferably 85 mass % or less and further preferably 80 mass % or less.

The liquid detergent composition of the present invention can contain a component that is added to common compositions used for treatment of textile products, and can contain, for example, a fragrance, a pH adjuster, a preservative, a pigment, a chelating agent, a hydrotropic agent or the like (with the proviso that components corresponding to any of component (a), component (b), component (c), component (d), component (e) and component (f) are excluded).

The pH of the liquid detergent composition of the present invention at 20° C. is preferably 4 or more, more preferably 5 or more and further preferably 6 or more from the viewpoint of improvement of washing performance for textile products, and preferably 10.5 or less, more preferably 10 or less and further preferably 9.5 or less from the viewpoint of maintenance of performance in long-term storage. The pH is measured according to a pH measurement method described below. For adjusting the pH to such a value, a common acid such as sulfuric acid, hydrochloric acid, phosphoric acid, acetic acid, lactic acid or the like and an alkali agent such as sodium hydroxide, potassium hydroxide, sodium carbonate, alkanolamine or the like can be used.

### pH Measurement Method

A composite electrode for pH measurements (manufactured by HORIBA, Ltd., glass slide-in sleeve type) is connected to a ph meter (manufactured by HORIBA, Ltd., pH/ion meter F-23), and the power is turned on. A saturated potassium chloride aqueous solution (3.33 mol/L) is used as the internal solution for the pH electrode, Next, a pH 4.01 standard solution (phthalate standard solution), a pH 6.86 standard solution (neutral phosphate standard solution) and a pH 9.18 standard solution (borate standard solution) are each placed in a 100-ml beaker, and immersed in a constant temperature bath at 20° C. for 30 minutes. The electrode for pH measurements is immersed in the standard solutions at an adjusted constant temperature for 3 minutes to perform a calibration operation in the order of pH 6.86, pH 9.18 and pH 4.01. The temperature of a sample to be measured is adjusted to 20° C., the electrode of the pH meter is immersed in the sample, and the pH 1 minute later is measured,

The viscosity of the liquid detergent composition of the present invention at 20° C. is preferably 10 mPa·s or more, more preferably 30 mPa·s or more and further preferably 50 mPa·s or more, and preferably 400 mPa·s or less, more preferably 300 mPa·s or less and further preferably 200 mPa·s or less from the viewpoint of easiness in handling. Note that the viscosity is one measured by using a B-type viscometer (manufactured by TOKYO KEIKI INC., VISCOMETER MODEL DVM-B) with a rotor No. 3 or 4 at a rotational frequency of 60 r/min for a measurement time of 60 seconds. A rotor suitable for the viscosity of a sample is selected; however, if viscosity regions that can be measured overlap with each other and different numerical values are obtained, a numerical value measured with a rotor No. 3 is employed.

The liquid detergent composition of the present invention can be suitably used for washing textile products.

The fibers to be washed with the liquid detergent composition of the present invention may be either hydrophobic fibers or hydrophilic fibers. Examples of the hydrophobic fibers include, for example, protein fibers (milk protein casein fiber, promix or the like), polyamide fibers (nylon or the like), polyester fibers (polyester or the like), polyacrylonitrile fibers (acrylic or the like), polyvinyl alcohol fibers (vinylon or the like), polyvinyl chloride fibers (polyvinyl chloride or the like), polyvinylidene chloride fibers (vinylidene or the like), polyolefin fibers (polyethylene, polypropylene or the like), polyurethane fibers (polyurethane or the like), polyvinyl chloride/polyvinyl alcohol copolymer fibers (polyclar or the like), polyalkylene paraoxybenzoate fibers (benzoate or the like), polyfluoroethylene fibers (polytetrafluoroethylene or the like), glass fibers, carbon fibers, alumina fibers, silicon carbide fibers, rock fibers, slag fibers, metal fibers (gold threads, silver threads, steel fibers) and others. Examples of the hydrophilic fibers include, for example, seed hair fibers (cotton, kapok or the like), bast fibers (hemp, flax, ramie, cannabis, jute or the like), vein fibers (manila hemp, sisal hemp or the like), palm fibers, juncus, straw, animal hair fibers (wool, mohair, cashmere, camel hair, alpaca, vicuna, angora or the like), silk fibers (domestic silk, wild silk), feathers, cellulose fibers (rayon, polynosic, cupro, acetate or the like) and others.

The fibers are preferably fibers including cotton fiber from the viewpoint of readily appreciable finishing performance for fibers after being washed with the liquid detergent composition of the present invention. From the viewpoint of finishing performance for fibers, a content of cotton fiber in the fibers is preferably 5 mass % or more, more preferably 10 mass % or more, further preferably 15 mass % or more, furthermore preferably 20 mass % or more, furthermore preferably 40 mass % or more, furthermore preferably 60 mass % or more and furthermore preferably 80 mass % or more, and preferably 100 mass % or less, and may be 100 mass %.

In the present invention, a textile product means fabrics such as woven fabrics, knitted fabrics, nonwoven fabrics or the like using any of the above hydrophobic fibers or hydrophilic fibers, and products obtained by using them, such as undershirts, T-shirts, dress shirts, blouses, slacks, caps, handkerchiefs, towels, knitwear, socks, underwear, tights or the like.

The liquid detergent composition of the present invention is suitable for washing textile products in water containing a hardness component. The phrase “suitable for washing textile products in water containing a hardness component” means that even when a textile product is washed with the liquid detergent composition of the present invention in water containing a hardness component, the textile product can be softened and finished to have clean appearance with reduced wrinkles, and sebum stains adhering to the textile product can be washed off.

The hardness of the water containing a hardness component for use in washing is preferably 8° dH or more, more preferably 8.5° dH or more, further preferably 9° dH or more, and preferably 20° dH or less, more preferably 17° dH or less and further preferably 15° dH or less in German hardness from the viewpoints of anti-wrinkle performance and softening performance for textile products.

German hardness (° dH) in the present specification refers to a value calculated from calcium and magnesium concentrations in water expressed in terms of CaCO₃ with the relationship 1 mg/L (ppm)=approximately 0.056° dH (1° dH=17.8 ppm)

The calcium and magnesium concentrations for German hardness are determined with chelate titration using ethylenediaminetetraacetate disodium salt.

A specific method for measuring the German hardness of water in the present specification is as follows.

### Method for Measuring German Hardness of Water

### Reagent

0.01 mol/l EDTA.2Na solution: a 0.01 mol/l aqueous solution of disodium ethylenediaminetetraacetate (a solution for titration, 0.01 M EDTA-2Na, manufactured by Sigma-Aldrich Co. LLC)
Indicator Universal BT (product name: Universal BT, manufactured by DOJINDO LABORATORIES)
Ammonia buffer solution for hardness measurements (a solution obtained by dissolving 67.5 g of ammonium chloride in 570 ml of 28 w/v % ammonia water and making the total amount 1000 ml with ion-exchanged water)

### Measurement of Hardness

(1) 20 ml of water as a sample is collected in a conical beaker with a volumetric pipette.
(2) 2 ml of the ammonia buffer solution for hardness measurements is added thereto.
(3) 0.5 ml of indicator Universal BT is added thereto. The solution after the addition is confirmed to be reddish purple.
(4) 0.01 mol/l EDTA.2Na solution is added dropwise from a burette while shaking the conical beaker well, and the point of time when the sample water turned blue is taken as the end point of titration.
(5) The total hardness is determined by the following calculation formula:

$$Hardness ( ° dH ) = T \times 0.01 \times F \times 56.0774 \times 100 / A$$

T: titration amount of 0.01 mol/l EDTA.2Na solution (mL)
A: volume of sample (20 mL, volume of sample water)
F: factor for 0.01 mol/l EDTA.2Na solution

### Method for Washing Textile Products

The present invention provides a method for washing textile products, including washing textile products with a washing liquid containing: (a) an internal olefin sulfonate with 16 or more and 24 or less carbons (hereinafter referred to as component (a)); (b) a cationic surfactant (hereinafter referred to as component (b)); (c) a nonionic surfactant (hereinafter referred to as component (c)); and water.

In the method for washing textile products of the present invention, the washing liquid is preferably obtained by mixing the liquid detergent composition of the present invention and water.

The washing liquid can further contain component (d). In addition, the washing liquid can further contain component (e). In addition, the washing liquid can further contain component (f). The aspects of component (a), component (b), component (c), component (d), component (e) and component (f) are the same as those described for the liquid detergent composition of the present invention.

The aspect described for the liquid detergent composition of the present invention can be appropriately applied to the method for washing textile products of the present invention.

The hardness of the water to be mixed with the liquid detergent composition of the present invention for the washing liquid is preferably 8° dH or more, more preferably 8.5° dH or more and further preferably 9° dH or more, and preferably 20° dH or less, more preferably 17° dH or less and further preferably 15° dH or less in German hardness from the viewpoints of anti-wrinkle performance and softening performance for textile products.

The hardness of the washing liquid may be in the above range.

In the method for washing textile products of the present invention, the hardness of the washing liquid is a value calculated according to “Method for measuring German hardness of water.” Further, a hardness can be selected for the washing liquid from the preferred range of the hardness of water containing a hardness component as described for the liquid detergent composition of the present invention. The hardness of the washing liquid can also be measured with the measurement method same as that of the above hardness of water. Further, also for water for use in the washing method such as water for use in preparing the washing liquid, water for use in rinsing, or the like, a hardness can be selected from the preferred range of the hardness of water containing a hardness component as described for the liquid detergent composition of the present invention. The hardness of water can also be measured with the measurement method same as that of the above hardness of water.

A content of component (a) in the washing liquid is preferably 40 ppm or more, more preferably 45 ppm or more and further preferably 50 ppm or more, and preferably 1200 ppm or less, more preferably 900 ppm or less and further preferably 600 ppm or less.

A content of component (b) in the washing liquid is preferably 25 ppm or more, more preferably 30 ppm or more and further preferably 37.5 ppm or more, and preferably 600 ppm or less, more preferably 450 ppm or less and further preferably 300 ppm or less.

A content of component (c) in the washing liquid is preferably 75 ppm or more, more preferably 100 ppm or more and further preferably 120 ppm or more, and preferably 1050 ppm or less, more preferably 900 ppm or less and further preferably 750 ppm or less.

A mass ratio of a content of component (a) to a content of component (b), (a)/(b), and a mass ratio of a content of component (c) to a total content of component (a) and component (b), (c)/[(a)+(b)], in the washing liquid are preferably within the same respective ranges as in the liquid detergent composition of the present invention.

If the washing liquid contains component (d), a content of component (d) in the washing liquid is preferably 5 ppm or more, more preferably 10 ppm or more and further preferably 15 ppm or more, and preferably 150 ppm or less, more preferably 120 ppm or less and further preferably 90 ppm or less. A mass ratio of a content of Component (a) to a content of component (d), (a)/(d), in the washing liquid is preferably in the same range as in the liquid detergent composition of the present invention.

If the washing liquid contains component (e), a content of component (e) in the washing liquid is preferably 5 ppm or more, more preferably 10 ppm or more and further preferably 15 ppm or more, and preferably 450 ppm or less, more preferably 300 ppm or less and further preferably 210 ppm or less.

The temperature of the washing liquid is preferably 0° C. or more, more preferably 3° C. or more, further preferably 5° C. or more from the viewpoint of capability of achieving more improved washing performance to stains adhering to textile products, and preferably 40° C. or less and more preferably 35° C. or less from the viewpoint of capability of finishing textile products with higher softness and fewer wrinkles without excessively washing off an oil agent contained in the fiber itself constituting a textile product.

The pH of the washing liquid at 20° C. is 5 or more, preferably 6 or more and more preferably 7 or more from the viewpoint of improvement of washing performance to stains adhering to textile products, and 10.5 or less, preferably 10 or less and more preferably 9.5 or less from the viewpoints of preventing fibers from being damaged and thus not inhibiting finishing performance. The pH of the washing liquid can be measured with the same measurement method as the pH of the liquid detergent composition,

The recent upsizing of washing machines has resulted in a tendency of smaller bath ratios, each represented by a ratio of the liquid amount of a washing liquid (L) to the mass of clothing (kg), that is, liquid amount of washing liquid (L)/mass of clothing (kg) (hereinafter this ratio is sometimes referred to as the bath ratio). In using a washing machine for home use, the decrease of the bath ratio may cause larger friction among textile products through stirring in washing to deteriorate the finishing performance for textile products. The method for washing textile products of the present invention allows textile products to be finished with softness and clean appearance even under washing conditions with a small bath ratio. The bath ratio is preferably 2 or more, more preferably 3 or more, further preferably 4 or more and furthermore preferably 5 or more from the viewpoint of finishing textile products with higher softness and cleanliness, and preferably 45 or less, more preferably 40 or less, further preferably 30 or less and furthermore preferably 20 or less from the viewpoint of keeping the detergency.

The washing time in the method for washing textile products of the present invention is preferably 1 minute or more, more preferably 2 minutes or more and further preferably 3 minutes or more from the viewpoints of washing performance to sebum stains and anti-wrinkle performance for textile products, and preferably 1 hour or less, more preferably 30 minutes or less, further preferably 20 minutes or less and furthermore preferably 15 minutes or less from the viewpoint of capability of finishing textile products with higher softness.

The method for washing textile products of the present invention is suitable for a method of soaking fibers in a liquid for use in scouring while the fibers are sent with a roller or the like and for a rotary washing method. The rotary washing method is a washing method in which textile products that are not fixed to a rotating device rotate together with a washing liquid about a rotational axis. The rotary washing method can be carried out with a rotary washing machine. Accordingly, in the present invention, washing of textile products is preferably performed with a rotary washing machine in terms of finishing the textile products with higher cleanliness. Specific examples of the rotary washing machine include, for example, a drum-type washing machine, a pulsator-type washing machine or an agitator-type washing machine. As these rotary washing machines, commercially available ones for home use can be used.

### EXAMPLES

### Formulation Components

The following components were used for examples and comparative examples.

### Component (a)

### a-1: A Sodium Salt of an Internal Olefin Sulfonate with 18 Carbons

A mass ratio of olefin species (sodium olefin sulfonates)/hydroxy species (sodium hydroxy alkane sulfonates) in a-1 is 16/84. A mass ratio of a position distribution of a sulfonic acid group in HAS species is as follows:
position 1/position 2/position 3/position 4/position 5/positions 6 to 9=1.5/22.1/17.2/21.8/13.5/23.9 (mass ratio)

Further, (IO-1S)/(IO-2S) is equal to 1.6 by mass ratio.

The position distribution of a sulfonic acid group in HAS species contained in the internal olefin sulfonate of a-1 and the mass ratio of olefin species to hydroxy species (HAS species) were measured with a high-performance liquid chromatography mass spectrometry. Note that an internal olefin sulfonate in which a double bond is present at position 6 or more could not be clearly fractionated due to overlapping peaks. The devices and analysis conditions used for the measurements are the following.

### Measurement Instrument

LC device: “LC-20ASXR” (manufactured by Shimadzu Corporation)
LC-MS device: “LCMS-2020” (manufactured by Shimadzu Corporation)
Column: ODS Hypersil (length: 250 mm, inner diameter: 4.6 mm, particle size: 3 μm, manufactured by Thermo Fisher Scientific, Inc.)
Detector: ESI(-), m/z=349.15 (C18), 321.10 (C16), 293.05 (C14)

### Solvent

Solvent A: 10 mM ammonium acetate aqueous solution
Solvent B: acetonitrile/water=95/5 solution with 10 mM ammonium acetate added

### Elution Conditions

Gradient: solvent A 60%, solvent B 40% (0 to 15 min)→solvent A 30%, solvent B 70% (15.1 to 20 min)→solvent A 60%, solvent B 40% (20.1 to 30 min)
Flow rate: 0.5 ml/min
Column temperature: 40° C.
Injection volume: 5 μl

### Component (a′) (Comparative Component for Component (a))

a′-1: sodium polyoxyethylene (2) alkyl ether sulfate, the number in the parentheses is the average number of added moles of oxyethylene groups, “EMAL 270J,” manufactured by Kao Corporation
a′-2: sodium dodecylbenzenesulfonate, “NEOPELEX G-25,” manufactured by Kao Corporation, purity: 25%

### Component (b)

b-1: lauryltrimethylammonium chloride, a compound of the general formula (b1) in which R^{1b} is an alkyl group with 12 carbons, R^{2b}, R^{3b} and R^{4b} are methyl groups and X⁻ is a chloride ion, manufactured by Kao Corporation
b-2: cetyltrimethylammonium chloride, a compound of the general formula (b1) in which R^{1b} is an alkyl group with 16 carbons, R^{2b}, R^{3b} and R^{4b} are methyl groups and X⁻ is a chloride ion, “QUARTAMIN 60W,” manufactured by Kao Corporation
b-3: alkylbenzyldimethylammonium chloride, a compound of the general formula (b2) in which R^{5b} is an alkyl group with 12 to 16 carbons, R^{6b} and R^{7b} are methyl groups and X⁻ is a chloride ion, “SANISOL B-50,” manufactured by Kao Corporation
b-4: alkyl (carbon number: 14) N,N-dimethyl-N-ethylammonium ethylsulfate, a compound of the general formula (b1) in which R^{1b} is an alkyl group with 14 carbons, R^{2b} and R^{3b} are methyl groups, R^{4b} is an ethyl group and X⁻ is an ethylsulfate ion, “QUARTAMIN 40ES,” manufactured by Kao Corporation

### Component (c)

c-1: polyoxyethylene lauryl ether (average number of added moles of oxyethylene groups: 21 mol), a compound of the general formula (c1) in which R^{1c} is an alkyl group with 12 carbons, m is 0, AO represents ethyleneoxy group, n is 21 and R^{2c} is a hydrogen atom, “EMULGEN 121,” manufactured by Kao Corporation
c-2: polyoxyethylene alkyl ether (a compound obtained by adding 7 mol of ethyleneoxy group on average, then adding 1.5 mol of propyleneoxy group on average and further adding 7 mol of ethyleneoxy group on average per 1 mol of an aliphatic alcohol), a compound of the general formula (c1) in which R^{1c} is a mixed alkyl group of a lauryl group and a myristyl group with a mass ratio of a mass of the lauryl group to a mass of the myristyl group (lauryl group/myristyl group) being equal to 7/3, m is 0, AO represents ethyleneoxy group and propyleneoxy group, n is 15.5 and R^{2c} is a hydrogen atom, manufactured by Kao Corporation
c-3: polyoxyethylene lauryl ether (average number of added moles of oxyethylene groups: 6 mol), a compound of the general formula (c1) in which R^{1c} is a lauryl group, m is 0, AO represents ethyleneoxy group, n is 6 and R^{2c} is a hydrogen atom, “EMULGEN 108,” manufactured by Kao Corporation
c-4: polyoxyethylene alkyl ether (a compound obtained by adding 9 mol of ethyleneoxy group on average, then adding 2 mol of propyleneoxy group on average and further adding 9 mol of ethyleneoxy group on average per 1 mol of an aliphatic alcohol), a compound of the general formula (c1) in which R^{1c} is a mixed alkyl group of a lauryl group and a myristyl group with a mass ratio of a mass of the lauryl group to a mass of the myristyl group (lauryl group/myristyl group) being equal to 72/28, m is 0, AO represents ethyleneoxy group and propyleneoxy group, n is 20 and R^{2c} is a hydrogen atom, manufactured by Kao Corporation
c-5: polyoxyethylene alkyl ether (a compound obtained by adding 16.5 mol of ethyleneoxy group on average and then adding 3.7 mol of propyleneoxy group on average per 1 mol of an aliphatic alcohol), a compound of the general formula (c1) in which R^{1c} is a mixed alkyl group of a lauryl group and a myristyl group with a mass ratio of a mass of the lauryl group to a mass of the myristyl group (lauryl group/myristyl group) being equal to 72/28, m is 0, AO represents ethyleneoxy group and propyleneoxy group, n is 20.2 and R^{2c} is a hydrogen atom, manufactured by Kao Corporation

### Component (d)

d-1: caprylic acid, “LUNAC 8-98,” manufactured by Kao Corporation
d-2: decanoic acid, “LUNAC 10-98,” manufactured by Kao Corporation
d-3: lauric acid, “LUNAC L-98,” manufactured by Kao Corporation
d-4: myristic acid, “LUNAC MY-98,” manufactured by Kao Corporation

### Component (e)

e-1: 2-phenoxyethanol, manufactured by NIPPON NYUKAZAI CO., LTD.

### Component (f)

f-1: monoethanolamine, manufactured by Mitsui Chemicals, Inc.

### Water

Ion-exchanged water

### Preparation of Liquid Detergent Composition

With the above formulation components, liquid detergent compositions shown in Tables 1 and 2 were prepared by the following method.

A Teflon® stirrer piece with a length of 5 cm was placed in a glass beaker with a capacity of 200 mL, and the mass of them was measured, Next, 20 g of ion-exchanged water, component (a) or component (a′), component (b), component (c), component (d), component (e) and component (f) were placed therein, hydrochloric acid or sodium hydroxide was added with stirring at 100 r/min so that the pH of the composition reached a value shown in Table 1 or 2, and ion-exchanged water was added thereto to reach a total amount of 100 g. The resultant was stirred at 100 r/min for 15 minutes to prepare a liquid detergent composition. Note that the values in mass % for the formulation components in Tables 1 and 2 are all numerical values based on effective components.

### Evaluation of Liquid-Phase Stability

In a No. 6 glass standard bottle, 25 g of each of the prepared liquid detergent compositions was put, and the bottle was sealed with a cap. The liquid detergent composition was left to stand at room temperature of 25° C., and visually observed to perform evaluation on the basis of the criteria shown below. The results are shown in Tables 1 and 2.
Rank A: phase separation occurred after 1 day or more from leaving to stand, or no phase separation occurred.
Rank B: phase separation occurred in 8 to 24 hours of leaving to stand
Rank C: phase separation occurred in 4 to 8 hours of leaving to stand
Rank D; phase separation occurred in 0 to 4 hours of leaving to stand

### Evaluation of Washing Performance to Sebum Stain

### (1) Preparation of Model Sebum Artificial Stain Cloth

A model sebum artificial stain liquid of the composition shown below was adhered to cloth to prepare model sebum artificial stain cloth. The model sebum artificial stain liquid was printed on the cloth with a gravure roll coater, thereby adhering the artificial stain liquid to the cloth. The step of preparing the model sebum artificial stain liquid by adhering the model sebum artificial stain liquid to the cloth was carried out with a gravure roll cell capacity of 58 cm³/m², a coating rate of 1.0 m/min, a drying temperature of 100° C. and a drying time of 1 minute. Cotton 2003 (manufactured by Tanigashira Shoten) was used as the cloth.
The composition of the model sebum artificial stain liquid was as follows: lauric acid 0.4 mass %, myristic acid 3.1 mass %, pentadecanoic acid 2.3 mass %, palmitic acid 6.2 mass %, heptadecanoic acid 0.4 mass %, stearic acid 1,6 mass %, oleic acid 7.8 mass %, triolein 13.0 mass %, n-hexadecyl palmitate 2.2 mass %, squalene 6.5 mass %, egg white lecithin liquid crystal 1.9 mass %, Kanuma red soil 8.1 mass %, carbon black 0.01 mass %, and the balance of the composition was water (100 mass % in total).

### (2) Measurement of Washing Performance

Four pieces of the above prepared model sebum artificial stain cloth (6 cm×6 cm) were washed with a Terg-O-Tometer (manufactured by Ueshima Seisakusho Co., Ltd., MS-8212) at 60 rpm for 20 minutes. The washing condition was as follows: 1 L of water (the water was ion exchange water, in which the German hardness was adjusted to 14° dH by using calcium chloride and magnesium chloride at a ratio of Ca/Mg=6/4 (mass ratio), and the water temperature was adjusted to 30° C.) was poured so that each of the liquid detergent compositions shown in Table 1 or 2 was 2 g/L, and the washing was carried out with a water temperature at 30° C. After washing, rinsing with municipal water (20° C.) was carried out for 3 minutes. Thereafter, the stain cloth after rinsing was subjected to dehydration treatment for 1 minute with a twin-tub washing machine, and then left to stand for drying under conditions of 20° C. and 43% RH for 12 hours. The washing performance was evaluated on the basis of detergency. Detergency (%) was measured with a method shown below, and the average value for the four pieces was determined. Note that the reflectances at a wavelength of 550 nm of the original cloth before staining and the artificial stain cloth before and after washing were measured with a colorimeter (manufactured by NIPPON DENSHOKU INDUSTRIES CO., LTD., Z-300A).

$$Detergency ( \% ) = 100 \times [ ( reflectance of artificial stain cloth after washing - reflectance of artificial stain cloth before washing ) / ( reflectance of original cloth - reflectance of artificial stain cloth before washing ) ]$$

For the detergency (%) of the liquid detergent composition of each of examples and comparative examples, a sebum detergency increase rate was calculated from a calculation formula shown below with reference to the detergency of Comparative Example 3 (9.8%) not containing component (a) but containing a′-2, which is a comparative component for component (a). The results are shown in Tables 1 and 2.

$$Sebum detergency increase rate = detergency ( \% ) of each example / detergency ( \% ) of Comparative Example 3$$

### Evaluation of Softening Performance and Anti-Wrinkle Performance

### (1) Method for Pretreating Cloth for Use in Evaluation on Wrinkles

1.7 kg of Cotton broad (manufactured by Tanigashira Shoten) was subjected to cumulative washing twice (at the time of washing, 4.7 g of EMULGEN 108 (manufactured by Kao Corporation), water volume: 47 L, washing: 9 minutes, rinsing: twice, dehydration: 3 minutes), followed by cumulative washing of three times with water alone (water volume: 47 L, washing: 9 minutes, rinsing: twice, dehydration: 3 minutes) with an automatic washing machine (manufactured by National, NA-F702P) set to its standard course, and dried under an environment at 23° C. and 45% RH for 24 hours. Thereafter, the resultant was cut to give a textile of 30 cm×60 cm in size, which was then folded by aligning both ends of its short sides, and sewn with a sewing machine. This was used as a 30 cm×30 cm textile for evaluation.

Using a nonionic surfactant (ethylene oxide adduct of lauryl alcohol (average number of added moles: 8)), approximately 1.6 kg of commercially available cotton towels (hiorie towel, made in Japan, cotton 100%, 34 cm×86 cm, 12 towels) were subjected to cumulative washing five times (amount of nonionic surfactant used: 4.5 g, water volume: 45 L, water temperature: 20° C., washing time: 10 minutes, water-saving rinsing: twice) with an automatic washing machine (manufactured by Hitachi, Ltd., NW-6CY) set to its standard course, and dried under an environment at 25° C. and 45% RH for 24 hours in advance. The resultants were used as towels for evaluation.

10 T-shirts (manufactured by UNIQLO CO., LTD., 100% cotton) were subjected to cumulative washing twice (at the time of washing, 4.7 g of EMULGEN 108 (manufactured by Kao Corporation), water volume: 47 L, washing: 9 minutes, rinsing: twice, dehydration: 3 minutes), followed by cumulative washing of three times with water alone (water volume: 47 L, washing: 9 minutes, rinsing: twice, dehydration: 3 minutes) with an automatic washing machine (manufactured by National, NA-F702P) set to its standard course, and dried under an environment at 23° C. and 45% RH for 24 hours. The resultants were used as adjuster cloths.

### (2) Method for Evaluating Softening Performance and Anti-Wrinkle Performance

To an electric bucket-type washing machine (manufactured by National, model number: “N-BK2”), 4.0 L of hard water (12° dH, prepared by adding only calcium chloride to ion-exchanged water) was poured. Into the water in the washing machine, 2 g of each of the liquid detergent compositions was put, and the water was stirred for 1 minute. Thereafter, one piece of textile of Cotton broad for evaluation, one towel for evaluation and one adjuster cloth being a T-shirt, which had been pretreated with the above methods, were put therein, and washed for 10 minutes. After washing, the resultants were dehydrated with a twin-tub washing machine (manufactured by Hitachi, Ltd., model number: “PS-H35L”) for 1 minute. Next, 4.0 L of the hard water was poured into the bucket-type washing machine, into which the textile for evaluation, the towel for evaluation and the adjuster cloth after being dehydrated were put, and subjected to rinsing treatment for 3 minutes. Thereafter, the same dehydration treatment was carried out with a twin-tub washing machine for 1 minute. After that rinsing treatment was performed twice in total, the textile of Cotton broad for evaluation was straightened out, lightly shaken 10 times, and hung and dried under an environment at 25° C. and 45% RH for 24 hours. The towel for evaluation was dried under conditions of 25° C. and 45% RH for 24 hours.

### (3) Method for Assessing Softening Performance after Washing

For each of the towels for evaluation washed and dried under the above conditions, six skilled assessors separately compared each towel for evaluation with the towel of Comparative Example 3 for evaluation, and performed rating on the basis of the following criteria.
3 points: very soft
2 points: soft
1 point: slightly soft
0 points: the same softness
−1 point: slightly hard
−2 points: hard
−3 points: very hard

An average value was calculated from evaluation values given by the six assessors and rounded to two decimal places to give a score for assessment on the basis of the criteria shown below. The results are shown in Tables 1 and 2.
Rank A: 1.5 or more
Rank B: 1.0 or more and less than 1.5
Rank C: 0.5 or more and less than 1.0
Rank D: less than 0.5

### (4) Method for Assessing Wrinkles after Washing

Test was carried out with reference to JIS L 1096: 2010 8.24. One piece of textile for evaluation was attached to and vertically placed on an observation plate placed in a dark room. Assessment references were placed on both sides thereof. Six skilled observers separately assessed each of the textiles for evaluation, where, first, one observer stood in front of the textile for evaluation 122 cm apart from the observation plate and compared the appearance of the textile for evaluation with those of the assessment references to assess the grade on the basis of the criteria shown below; the other five observers also individually assessed the grade of the textile for evaluation. Higher grades indicate better appearance with fewer wrinkles.

The illuminance in the evaluation room was adjusted with eight starter-type white fluorescent lamps (Sunline FL20SSW/18-B, manufactured by HITACHI, Ltd.) attached in the dark room to keep a constant illuminance equivalent to 1000 lx.

The assessment references used in the assessment were six-grade wrinkle replicas (product code: AAT8353) in accordance with AATCC Test Method 124 (Appearance of Fabrics after Repeated Home Laundering).
Grade 5: with appearance comparable to that of the replica of assessment reference 5
Grade 4: with appearance comparable to that of the replica of assessment reference 4
Grade 3.5: with appearance comparable to that of the replica of assessment reference 3.5
Grade 3: with appearance comparable to that of the replica of assessment reference 3
Grade 2: with appearance comparable to that of the replica of assessment reference 2
Grade 1: with appearance comparable to or worse than that of the replica of assessment reference 1

For each of the textiles for evaluation treated with the respective liquid detergent compositions, an average value was calculated from assessment values given by the six observers and rounded to two decimal places to give a score, and the difference between the score of each example and the score of Comparative Example 3 (“score of each example”−“score of Comparative Example 3”) was calculated for assessment on the basis of the criteria shown below. The results are shown in Tables 1 and 2.
Rank A: 0.3 or more
Rank B: 0.0 or more and less than 0.3
Rank C: −0.3 or more and less than 0.0
Rank D: less than −0.3

TABLE 1

| | | | | Example | | | | | | | | | |
|---|---|---|---|---|---|---|---|---|---|---|---|---|---|
| | | | | 1 | 2 | 3 | 4 | 5 | 6 | 7 | 8 | 9 | 10 |
| Liquid | Formulation | (a) | a-1 | 13.5 | 10.8 | 9 | 6 | 18.8 | 16.5 | 11.3 | 6 | 6 | 6 |
| detergent | components | (b) | b-1 | | | | | | | | 4 | | |
| composition | (mass %) | | b-2 | 9 | 7.2 | 6 | 4 | 3.75 | 6 | 11.3 | | | |
| | | | b-3 | | | | | | | | | 4 | |
| | | | b-4 | | | | | | | | | | 4 |
| | | (c) | c-1 | 7.5 | 12 | 15 | 20 | 7.5 | 7.5 | 7.5 | 20 | 20 | 20 |
| | | | c-2 | | | | | | | | | | |
| | | | c-3 | | | | | | | | | | |
| | | | c-4 | | | | | | | | | | |
| | | | c-5 | | | | | | | | | | |
| | | (d) | d-1 | | | | | | | | | | |
| | | | d-2 | | | | | | | | | | |
| | | | d-3 | | | | | | | | | | |
| | | | d-4 | | | | | | | | | | |
| | | (e) | e-1 | 2 | 2 | 2 | 2 | 2 | 2 | 2 | 2 | 2 | 2 |
| | | (f) | f-1 | | | | | | | | | | |

| | | | | | | | | | | |
|---|---|---|---|---|---|---|---|---|---|---|
| Water | balance | balance | balance | balance | balance | balance | balance | balance | balance | balance |
| Total | 100 | 100 | 100 | 100 | 100 | 100 | 100 | 100 | 100 | 100 |

| | | | | | | | | | | | |
|---|---|---|---|---|---|---|---|---|---|---|---|
| | pH (20° C.) | 7.5 | 7.5 | 7.5 | 7.5 | 7.5 | 7.5 | 7.5 | 7.5 | 7.5 | 7.5 |
| | (a)/(b) (mass ratio) | 1.50 | 1.50 | 1.50 | 1.50 | 5.00 | 2.75 | 1.00 | 1.50 | 1.50 | 1.50 |
| | (c)/[(a) + (b)] (mass ratio) | 0.33 | 0.67 | 1.00 | 2.00 | 0.33 | 0.33 | 0.33 | 2.00 | 2.00 | 2.00 |
| Evaluation | Liquid-phase stability | B | B | A | A | A | B | A | A | A | A |
| | Sebum detergency increase rate | 1.7 | 2.5 | 3.0 | 3.9 | 2.6 | 1.7 | 1.8 | 3.1 | 3.4 | 3.2 |
| | Softening performance | A | B | B | B | B | A | A | B | B | B |
| | Anti-wrinkle performance | A | A | A | A | C | A | B | B | A | B |

| | | | | Example | | | | | | | | |
|---|---|---|---|---|---|---|---|---|---|---|---|---|
| | | | | 11 | 12 | 13 | 14 | 15 | 16 | 17 | 18 | 19 |
| Liquid | Formulation | (a) | a-1 | 6 | 6 | 6 | 6 | 6 | 6 | 6 | 6 | 6 |
| detergent | components | (b) | b-1 | | | | | | | | | |
| composition | (mass %) | | b-2 | 4 | 4 | 4 | 4 | 4 | 4 | 4 | 4 | |
| | | | b-3 | | | | | | | | | 4 |
| | | | b-4 | | | | | | | | | |
| | | (c) | c-1 | | | | | 20 | 20 | 20 | 20 | 20 |
| | | | c-2 | 20 | 16 | | | | | | | |
| | | | c-3 | | 4 | | | | | | | |
| | | | c-4 | | | 20 | | | | | | |
| | | | c-5 | | | | 20 | | | | | |
| | | (d) | d-1 | | | | | 2 | | | | |
| | | | d-2 | | | | | | 2 | | | |
| | | | d-3 | | | | | | | 2 | | 2 |
| | | | d-4 | | | | | | | | 2 | |
| | | (e) | e-1 | 2 | 2 | 2 | 2 | | | | | |
| | | (f) | f-1 | | | | | 0.9 | 0.9 | 0.9 | 0.9 | 0.9 |

| | | | | | | | | | |
|---|---|---|---|---|---|---|---|---|---|
| Water | balance | balance | balance | balance | balance | balance | balance | balance | balance |
| Total | 100 | 100 | 100 | 100 | 100 | 100 | 100 | 100 | 100 |

| | | | | | | | | | | |
|---|---|---|---|---|---|---|---|---|---|---|
| | pH (20° C.) | 7.5 | 7.5 | 7.5 | 7.5 | 9.0 | 9.0 | 9.0 | 9.0 | 9.0 |
| | (a)/(b) (mass ratio) | 1.50 | 1.50 | 1.50 | 1.50 | 1.50 | 1.50 | 1.50 | 1.50 | 1.50 |
| | (c)/[(a) + (b)] (mass ratio) | 2.00 | 2.00 | 2.00 | 2.00 | 2.00 | 2.00 | 2.00 | 2.00 | 2.00 |
| Evaluation | Liquid-phase stability | A | B | A | A | A | A | A | A | A |
| | Sebum detergency increase rate | 4.1 | 3.1 | 3.7 | 3.7 | 3.8 | 3.7 | 3.8 | 3.7 | 3.7 |
| | Softening performance | B | B | B | B | B | B | A | B | A |
| | Anti-wrinkle performance | A | A | A | A | A | A | A | B | A |

TABLE 2

| | | | | Comparative Example | | | | | |
|---|---|---|---|---|---|---|---|---|---|
| | | | | 1 | 2 | 3 | 4 | 5 | 6 |
| Liquid | Formulation | (a) | a-1 | 30 | | | | 22.5 | 18 |
| detergent | components | (a′) | a′-1 | | 30 | | | | |
| composition | (mass %) | | a′-2 | | | 30 | | | |
| | | (b) | b-2 | | | | | | |
| | | (c) | c-1 | | | | 30 | 7.5 | 12 |
| | | (e) | e-1 | | | | | | |

| | | | | | | |
|---|---|---|---|---|---|---|
| Water | balance | balance | balance | balance | balance | balance |
| Total | 100 | 100 | 100 | 100 | 100 | 100 |

| | | | | | | | |
|---|---|---|---|---|---|---|---|
| | pH (20° C.) | 7.5 | 7.5 | 7.5 | 7.5 | 7.5 | 7.5 |
| | (a)/(b) (mass ratio) | — | — | — | — | — | — |
| | (c)/[(a) + (b)] (mass ratio) | 0 | — | — | — | 0.33 | 0.67 |
| Evaluation | Liquid-phase stability | A | A | A | A | A | A |
| | Sebum detergency increase rate | 1.1 | 2.3 | reference | 2.2 | 2.4 | 2.5 |
| | Softening performance | B | D | reference | D | D | D |
| | Anti-wrinkle performance | A | D | reference | D | D | D |

| | | | | Comparative Example | | | | | |
|---|---|---|---|---|---|---|---|---|---|
| | | | | 7 | 8 | 9 | 10 | 11 | 12 |
| Liquid | Formulation | (a) | a-1 | 22.5 | 22.5 | | | | |
| detergent | components | (a′) | a′-1 | | 7.5 | | | 18.8 | |
| composition | (mass %) | | a′-2 | | | 22.5 | 18.8 | | |
| | | (b) | b-2 | 7.5 | | 7.5 | 3.75 | 3.75 | 22.5 |
| | | (c) | c-1 | | | | 7.5 | 7.5 | 7.5 |
| | | (e) | e-1 | | | | | | |

| | | | | | | |
|---|---|---|---|---|---|---|
| Water | balance | balance | balance | balance | balance | balance |
| Total | 100 | 100 | 100 | 100 | 100 | 100 |

| | | | | | | | |
|---|---|---|---|---|---|---|---|
| | pH (20° C.) | 7.5 | 7.5 | 7.5 | 7.5 | 7.5 | 7.5 |
| | (a)/(b) (mass ratio) | 3.00 | — | 0 | 0 | 0 | 0 |
| | (c)/[(a) + (b)] (mass ratio) | 0 | 0 | 0 | 2.00 | 2.00 | 0.33 |
| Evaluation | Liquid-phase stability | A | A | C | B | C | A |
| | Sebum detergency increase rate | 0.6 | 2.5 | −0.7 | 2.9 | 3.6 | 0.3 |
| | Softening performance | D | D | D | D | D | A |
| | Anti-wrinkle performance | C | D | A | B | D | D |

1. A liquid detergent composition, comprising:
component (a): an internal olefin sulfonate with 16 or more and 24 or less carbons;
component (b): a cationic surfactant;
component (c): a nonionic surfactant; and
water.

2. The liquid detergent composition according to claim 1, wherein (a)/(b), which is a mass ratio of a content of the component (a) to a content of the component (b) in the liquid detergent composition, is 0.8 or more and 5 or less.

3. The liquid detergent composition according to claim 1, wherein (c)/[(a)+(b)], which is a mass ratio of a content of the component (c) to a total content of the component (a) and the component (b) in the liquid detergent composition, is 0.3 or more and 2.5 or less.

4. The liquid detergent composition according to claim 1, wherein:
the component (a) comprises (IO-1S), which is an internal olefin sulfonate with a sulfonic acid group present at position 2 or more and 4 or less, and (IO-2S), which is an internal olefin sulfonate with a sulfonic acid group present at position 5 or more; and
(IO-1S)/(IO-2S), which is a mass ratio of a content of (IO-1S) to a content of (IO-2S), is 0.5 or more and 10 or less.

5. The liquid detergent composition according to claim 1, wherein
the component (b) comprises at least one selected from the group consisting of a compound represented by the following general formula (b1) and a compound represented by the following general formula (b2): 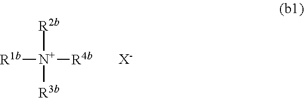
wherein:
R^{1b} is an aliphatic hydrocarbon group with 8 or more and 18 or less carbons,
R^{2b} is a group selected from the group consisting of an aliphatic hydrocarbon group with 8 or more and 18 or less carbons, an alkyl group with 1 or more and 3 or less carbons, and a hydroxyalkyl group with 1 or more and 3 or less carbons,
R^{3b} and R^{4b} are each independently a group selected from the group consisting of an alkyl group with 1 or more and 3 or less carbons and an hydroxyalkyl group with 1 or more and 3 or less carbons, and
X⁻ is an anion, and 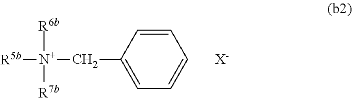
wherein
R^{5b} is an aliphatic hydrocarbon group with 8 or more and 18 or less carbons,
R^{6b} and R^{7b} are each independently a group selected from the group consisting of an alkyl group with 1 or more and 3 or less carbons and a hydroxyalkyl group with 1 or more and 3 or less carbons, and
X⁻ is an anion.

6. The liquid detergent composition according to claim 1, wherein the component (c) is a compound represented by the following general formula (c1):
R^{1c}(CO)ₘO—(AO)ₙ—R^{2c} (c1)
wherein
R^{1c} is an aliphatic hydrocarbon group with 8 or more and 18 or less carbons,
R^{2c} is a hydrogen atom or a methyl group,
CO is a carbonyl group,
m is a number of 0 or 1,
each AO group is an ethyleneoxy group or a propyleneoxy group, and
n is an average number of added moles, which is a number of 6 or more and 50 or less.

7. The liquid detergent composition according to claim 1, further comprising a fatty acid or a salt thereof as a component (d).

8. The liquid detergent composition according to claim 7, wherein the fatty acid as the component (d) has 8 or more and 14 or less carbons.

9. The liquid detergent composition according to claim 1, wherein the composition is formulated for use in washing textile products.

10. The liquid detergent composition according to claim 9, wherein the composition is formulated for use in washing textile products in water having a hardness of 8° dH or more and 20° dH or less.

11. A method for washing textile products, comprising washing textile products with a washing liquid comprising:
component (a): an internal olefin sulfonate with 16 or more and 24 or less carbons;
component (b): a cationic surfactant;
component (c); a nonionic surfactant; and
water.

12. The method for washing textile products according to claim 11, wherein (a)/(b), which is a mass ratio of a content of the component (a) to a content of the component (b) in the washing liquid, is 0.8 or more and 5 or less.

13. The method for washing textile products according to claim 11, wherein (c)/[(a)+(b)], which is a mass ratio of a content of the component (c) to a total content of the component (a) and the component (b) in the washing liquid, is 0.3 or more and 2.5 or less.

14. The method for washing textile products according to claim 11, wherein the washing liquid further comprises a fatty acid or a salt thereof as a component (d).

15. A method for washing textile products, comprising washing textile products with a washing liquid obtained by mixing the liquid detergent composition according to claim 1 and additional water.

16. The method for washing textile products according to claim 11, wherein the washing liquid has a hardness of 8° dH or more and 20° dH or less.

17. The liquid detergent composition according to claim 1, wherein a content of the component (a) in the liquid detergent composition is 4 mass % or more and 10 mass % or less.

18. The liquid detergent composition according to claim 1, wherein (c)/[(a)+(b)], which is a mass ratio of a content of the component (c) to a total content of the component (a) and the component (b) in the liquid detergent composition, is 0.7 or more and 2.5 or less.

19. The liquid detergent composition according to claim 1, wherein component (a) comprises an internal olefin sulfonate with 18 carbons.
